(19) United States
(12) Patent Application Publication
(10) Pub. No.: US 2023/0261288 A1
(43) Pub. Date: Aug. 17, 2023

(54) ELECTRONIC APPARATUS AND LAMINATED BATTERY

(71) Applicant: SONY GROUP CORPORATION, TOKYO (JP)

(72) Inventors: TATSUYA FURUYA, TOKYO (JP); HIDETOSHI AKASAWA, TOKYO (JP)

(21) Appl. No.: 18/003,803

(22) PCT Filed: Jul. 7, 2020
(86) PCT No.: PCT/JP2020/026544

§ 371 Date: Dec. 29, 2022

(51) Int. Cl. H01M 50/124; H01M 50/121; H01M 50/105

(52) U.S. Cl. CPC H01M 50/124; H01M 50/121; H01M 50/105

(57) ABSTRACT

An electronic apparatus (1) according to the present disclosure includes a laminated battery (10) and a hard film (20). The laminated battery (10) includes a battery element (14) and a laminate film (15) having a resin layer and covering the battery element (14). The hard film (20) is bonded to at least a part of a surface of the laminated battery (10). The hard film (20) is made of a material having an elongation percentage smaller than that of the resin layer.

### FIELD

The present disclosure relates to an electronic apparatus and a laminated battery.

### BACKGROUND

Conventionally, there has been known an electronic apparatus incorporating a laminated battery that is a secondary battery. The laminated battery is charged to make the electronic apparatus operable even when the electronic apparatus is disconnected from a commercial power supply (Patent Literature 1).

### CITATION LIST

### Patent Literature

Patent Literature 1: JP 2016-4627 A

### SUMMARY

### Technical Problem

The present disclosure proposes an electronic apparatus and a laminated battery capable of securing both capacity and reliability.

### Solution to Problem

According to the present disclosure, there is provided a electronic apparatus. The electronic apparatus includes a laminated battery and a hard film. The laminated battery includes a battery element and a laminate film having a resin layer and covering the battery element. The hard film is bonded to at least a part of a surface of the laminated battery. The hard film is made of a material having an elongation percentage smaller than that of the resin layer.

### Advantageous Effects of Invention

According to the present disclosure, both capacity and reliability can be secured. Note that the effects described herein are not necessarily limited, and may be any effects described in the present disclosure.

### BRIEF DESCRIPTION OF DRAWINGS

FIG. 1 is a diagram illustrating an outline of an electronic apparatus according to an embodiment of the present disclosure.

FIG. 2 is a diagram illustrating an outline of a laminated battery according to the embodiment of the present disclosure.

FIG. 3 is a cross-sectional view taken along line A-A illustrated in FIG. 2 as viewed in a direction of arrows.

FIG. 4 is a diagram illustrating a method of supporting a laminated battery of a reference example.

FIG. 5 is a diagram illustrating a method of supporting a laminated battery according to the embodiment of the present disclosure.

FIG. 6A is an upper perspective view illustrating an arrangement of a hard film with respect to the laminated battery according to the embodiment of the present disclosure.

FIG. 6B is a lower perspective view illustrating the arrangement of the hard film with respect to the laminated battery according to the embodiment of the present disclosure.

FIG. 7A is an upper perspective view illustrating an arrangement of a hard film with respect to a laminated battery according to a first modification of the embodiment of the present disclosure.

FIG. 7B is a lower perspective view illustrating the arrangement of the hard film with respect to the laminated battery according to the first modification of the embodiment of the present disclosure.

FIG. 8A is an upper perspective view illustrating an arrangement of a hard film with respect to a laminated battery according to a second modification of the embodiment of the present disclosure.

FIG. 8B is a lower perspective view illustrating the arrangement of the hard film with respect to the laminated battery according to the second modification of the embodiment of the present disclosure.

FIG. 9A is an upper perspective view illustrating an arrangement of a hard film with respect to a laminated battery according to a third modification of the embodiment of the present disclosure.

FIG. 9B is a lower perspective view illustrating the arrangement of the hard film with respect to the laminated battery according to the third modification of the embodiment of the present disclosure.

FIG. 10A is an upper perspective view illustrating an arrangement of a hard film with respect to a laminated battery according to a fourth modification of the embodiment of the present disclosure.

FIG. 10B is a lower perspective view illustrating the arrangement of the hard film with respect to the laminated battery according to the fourth modification of the embodiment of the present disclosure.

### DESCRIPTION OF EMBODIMENTS

Hereinafter, embodiments of the present disclosure will be described with reference to the drawings. In each of the following embodiments, same parts are given the same reference signs to omit redundant description.

Conventionally, there has been known an electronic apparatus incorporating a laminated battery that is a secondary battery. The laminated battery is charged to make the electronic apparatus operable even when the electronic apparatus is disconnected from a commercial power supply. In addition, in order to suppress a failure of the laminated battery when an impact is applied, a periphery of the laminated battery may be reinforced by various reinforcing members in the electronic apparatus.

However, in the above-described conventional technique, since the reinforcing member takes up a space inside the electronic apparatus, a capacity of the laminated battery has to be reduced accordingly. In other words, in the above-described conventional technique, it is difficult to secure both the capacity and reliability of the laminated battery provided in the electronic apparatus.

Therefore, a technique capable of overcoming the above-described disadvantage to secure both the capacity and reliability of the laminated battery has been expected.

[Electronic Apparatus and Laminated Battery]

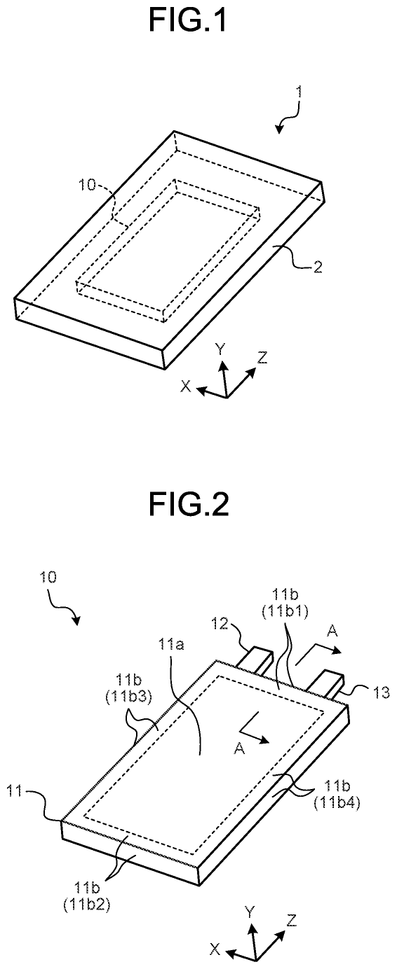

First, an outline of an electronic apparatus 1 and a laminated battery 10 according to the embodiment will be described with reference to FIGS. 1 to 3. FIG. 1 is a diagram illustrating the outline of the electronic apparatus 1 according to the embodiment of the present disclosure. Hereinafter, an X axis, a Y axis, and a Z axis orthogonal to each other are defined in order to clarify the positional relationship.

The electronic apparatus 1 according to the embodiment is, for example, a mobile phone such as a smartphone. Note that the electronic apparatus 1 according to the embodiment is not limited to the mobile phone, and may be a portable music device, a tablet terminal, a laptop computer, a virtual reality (VR) terminal, a controller such as for a game machine, various robots such as a drone, a power driver, and a cleaning robot, an electronic cigarette, or the like.

As illustrated in FIG. 1, the electronic apparatus 1 according to the embodiment includes a housing 2 and the laminated battery 10. The housing 2 houses the laminated battery 10 and various components (not illustrated) configuring the electronic apparatus 1.

In addition, the housing 2 according to the embodiment also functions as a support that supports the laminated battery 10 so that the laminated battery 10 does not move inside. In other words, the housing 2 according to the embodiment is an example of the support.

In the embodiment, the support that supports the laminated battery 10 is not limited to the housing 2, and various components configuring the electronic apparatus 1 may support the laminated battery 10.

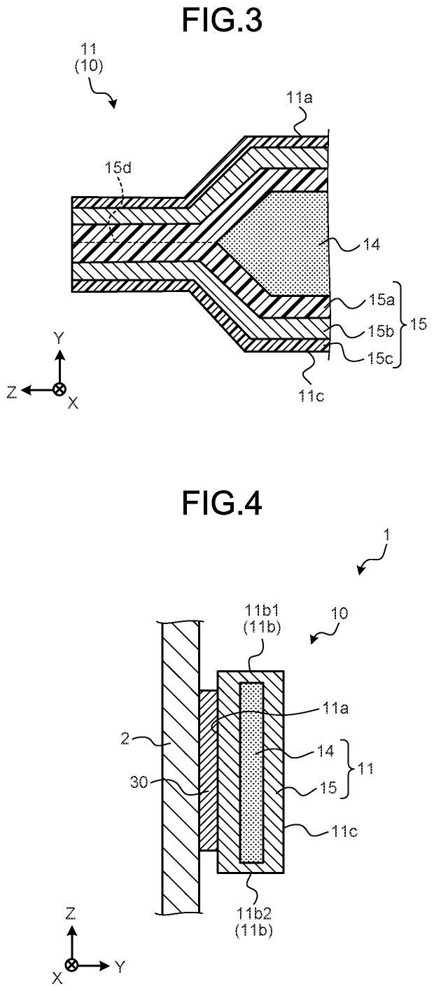

FIG. 2 is a diagram illustrating an outline of the laminated battery 10 according to the embodiment of the present disclosure, and FIG. 3 is a cross-sectional view taken along line A-A in FIG. 2 as viewed in a direction of arrows. As illustrated in FIG. 2, the laminated battery 10 according to the embodiment includes a main body 11, a positive electrode terminal 12, and a negative electrode terminal 13.

The main body 11 is, for example, a flat plate with a rectangular shape in a plan view. Note that, in the present disclosure, the main body 11 is not limited to the rectangular shape in a plan view, and may have, for example, a circular shape, a substantially L shape, or the like. Furthermore, in the present disclosure, the main body 11 is not limited to the flat plate shape, and may be, for example, a cylindrical shape or the like.

As illustrated in FIG. 2, the main body 11 has one main surface 11a, an edge part 11b, and the other main surface 11c (see FIG. 3). The main surface 11a faces the housing 2 that is the support and is supported by the housing 2. In the present disclosure, the main surface 11a faces a positive direction of the Y axis.

The edge part 11b includes an entire side surface of the main body 11 and frame-shaped portions, provided on the main surfaces 11a and 11c, having a predetermined width along the entire side surface. The edge part 11b has a first edge part 11b1, a second edge part 11b2, a third edge part 11b3, and a fourth edge part 11b4.

The first edge part 11b1 is a portion including a side surface on which the positive electrode terminal 12 and the negative electrode terminal 13 are provided (surface facing a positive direction of the Z axis in the present disclosure). The second edge part 11b2 is a portion including a side surface provided on an opposite side of the first edge part 11b1 (surface facing a negative direction of the Z-axis in the present disclosure).

The third edge part 11b3 is a portion including one side surface perpendicular to the main surface 11a, the first edge part 11b1, and the second edge part 11b2 (surface facing a positive direction of the X axis in the present disclosure). The fourth edge part 11b4 is a portion including a side surface provided on the opposite side of the third edge part 11b3 (surface facing a negative direction of the X axis in the present disclosure).

The positive electrode terminal 12 is a terminal connected to a positive electrode current collector (not illustrated) of a battery element 14 (see FIG. 3) provided inside the main body 11. The negative electrode terminal 13 is a terminal connected to a negative electrode current collector (not illustrated) of the battery element 14.

FIG. 3 is a cross-sectional view taken along line A-A in FIG. 2 as viewed in the direction of arrows, and is a diagram illustrating an internal structure of the laminated battery 10. As illustrated in FIG. 3, the main body 11 of the laminated battery 10 includes the battery element 14 and a laminate film 15.

The battery element 14 is, for example, a secondary battery such as a lithium ion battery, and is configured by winding the positive electrode current collector and the negative electrode current collector with a separator (not illustrated) interposed therebetween. In the embodiment, a winding axis of the battery element 14 is disposed along the Z axis. In the embodiment, an electrode structure of the battery element 14 is not limited to the winding type, and may be configured as a laminated type.

The laminate film 15 is provided so as to cover the entire battery element 14 and protect the battery element 14. The laminate film 15 is configured by laminating a first resin layer 15a, a metal layer 15b, and a second resin layer 15c in this order from an inner side (i.e., side of the battery element 14). The first resin layer 15a and the second resin layer 15c are examples of the resin layer.

The first resin layer 15a has a function of sealing an electrolytic solution (not illustrated) contained in the battery element 14. The first resin layer 15a is made of, for example, a resin such as polypropylene or polyethylene having a high chemical resistance and high water blocking performance.

The metal layer 15b has a function of preventing moisture from entering the battery element 14 from outside. The metal layer 15b is made of, for example, a metal having high moisture blocking performance such as aluminum or stainless steel.

The second resin layer 15c has a function of protecting the surface of the main body 11. The second resin layer 15c is made of, for example, a resin having high physical and chemical protection performance, insulation performance, and the like such as nylon.

The laminated battery 10 according to the embodiment is formed, for example, by inserting the battery element 14 to which the positive electrode terminal 12 and the negative electrode terminal 13 are attached into a bag-shaped laminate film 15, and then sealing the opening of the laminate film 15. In other words, as illustrated in FIG. 3, the laminated battery 10 is provided with a sealed part 15d formed by sealing an opening of the laminate film 15.

### Embodiment

Next, details of a method of supporting the laminated battery 10 in the electronic apparatus 1 according to the embodiment will be described with reference to FIGS. 4 to 6B. First, a subject of the present disclosure will be described with reference to FIG. 4. FIG. 4 is a diagram illustrating a method of supporting the laminated battery 10 of a reference example.

As illustrated in FIG. 4, in the electronic apparatus 1 of the reference example, the main body 11 of the laminated battery 10 is fixed to the housing 2 with a double-sided tape 30. The double-sided tape 30 is attached to the main surface 11a of the main body 11.

In this reference example, when an impact is applied to the electronic apparatus 1, the battery element 14 greatly moves inside the laminated battery 10 along a direction in which an impact is applied. The reason for this is as follows. The first resin layer 15a and the second resin layer 15c used in the laminate film 15 of the laminated battery 10 are both made of a resin having a large elongation percentage.

Therefore, when an external impact is applied to the electronic apparatus 1, the laminate film 15 directly supporting the battery element 14 greatly stretches. Then, since the laminate film 15 is stretched, the battery element 14 to which the external impact is applied greatly moves inside.

In particular, when the impact in the Z-axis direction is applied to the electronic apparatus 1, the battery element 14 may greatly move in the Z-axis direction, and the positive electrode current collector and the negative electrode current collector may be displaced along the winding axis. This may deteriorate reliability of the battery element 14.

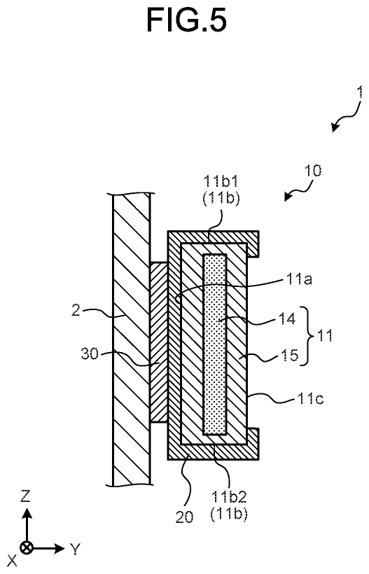

Therefore, in the embodiment, the method of supporting the laminated battery 10 in the electronic apparatus 1 has been changed as follows. FIG. 5 is a diagram illustrating the method of supporting the laminated battery 10 according to the embodiment of the present disclosure.

As illustrated in FIG. 5, in the electronic apparatus 1 according to the embodiment, a hard film 20 is bonded to at least a part of the surface of the main body 11 of the laminated battery 10. The hard film 20 is made of a material having a smaller elongation percentage than the resin layer (i.e., first resin layer 15a and second resin layer 15c) included in the laminate film 15. The hard film 20 is bonded to the surface of the main body 11 using an adhesive, a pressure-sensitive adhesive, or the like.

In the embodiment, by bonding the hard film 20 to at least a part of the surface of the laminated battery 10, the laminate film 15 can be made difficult to stretch. As a result, when the external impact is applied to the electronic apparatus 1, the battery element 14 can be suppressed from moving inside.

Therefore, according to the embodiment, the reliability of the laminated battery 10 can be improved.

In addition, in the embodiment, since the thin hard film 20 is simply attached to at least a part of the surface of the laminated battery 10, a space inside the electronic apparatus 1 required for protecting the laminated battery 10 can be reduced. In other words, in the embodiment, the capacity of the laminated battery 10 can be increased as compared with a case where a reinforcing member is provided around the laminated battery 10.

As described above, in the embodiment, by bonding the hard film 20 to at least a part of the surface of the laminated battery 10, both the capacity and reliability of the laminated battery 10 can be secured.

In the embodiment, a thickness of the hard film 20 is preferably in a range from 30 μm to 100 μm. When the thickness of the hard film 20 is smaller than 30 μm, a strength of the hard film 20 is reduced, and thus a function of making the laminate film 15 difficult to stretch is reduced.

On the other hand, when the thickness of the hard film 20 is larger than 100 μm, the space inside the electronic apparatus 1 necessary for protecting the laminated battery 10 becomes large, and thus the capacity of the laminated battery 10 becomes small.

Furthermore, when the thickness of the hard film 20 is made larger than 100 μm, workability of the hard film 20 required when the hard film 20 is bonded to the laminated battery 10 is also deteriorated.

In other words, in the embodiment, by setting the thickness of the hard film 20 in the range from 30 μm to 100 μm, it is possible to secure both the capacity and the reliability of the laminated battery 10 at a high level and also improve the workability of the hard film 20.

In the embodiment, the thickness of the hard film 20 is more preferably in a range from 30 μm to 50 μm. This makes it possible to secure both the capacity and reliability of the laminated battery 10 at a higher level, and to further improve the workability of the hard film 20.

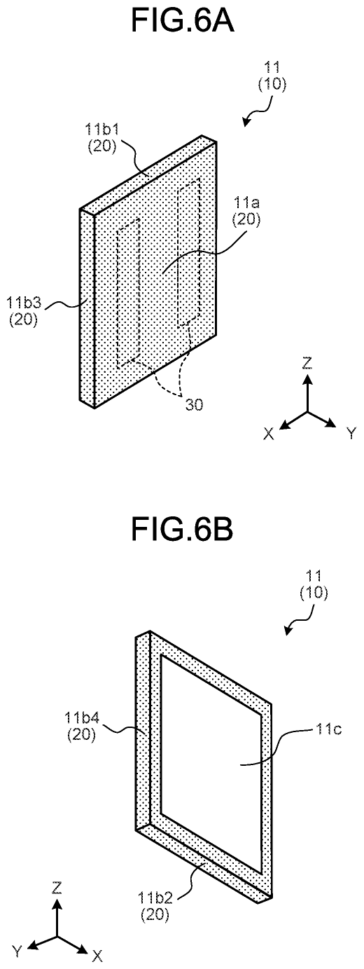

FIG. 6A is an upper perspective view illustrating an arrangement of the hard film 20 with respect to the laminated battery 10 according to the embodiment of the present disclosure, and FIG. 6B is a lower perspective view illustrating the arrangement of the hard film 20 with respect to the laminated battery 10 according to the embodiment of the present disclosure.

Note that, in the subsequent drawings, in order to facilitate understanding, dotted hatching is applied to a portion where the hard film 20 is disposed, and a portion where the double-sided tape 30 is attached is indicated by a broken line.

In the main body 11 of the laminated battery 10 according to the embodiment, as illustrated in FIGS. 6A and 6B, the hard film 20 is bonded to the entire main surface 11a, to which the double-sided tape 30 is attached, and the first edge part 11b1 to the fourth edge part 11b4 (i.e., entire edge part 11b). In other words, in the embodiment, as also illustrated in FIG. 5, the laminated battery 10 is supported by the housing 2 via the hard film 20.

As described above, by fixing the laminated battery 10 to the housing 2 via the hard film 20, it is possible to suppress deformation of the laminate film 15 in a vicinity of a bonding portion to which the double-sided tape 30 is bonded.

Therefore, according to the embodiment, since the battery element 14 can be further suppressed from moving inside, the reliability of the laminated battery 10 can be further improved.

In the embodiment, as illustrated in FIG. 6A, the hard film 20 may be provided so as to cover the entire main surface 11a to which the double-sided tape 30 is attached. As a result, it is possible to suppress deformation of the laminate film 15 in the vicinity of the bonding portion to which the double-sided tape 30 is bonded and in a periphery of the bonding portion.

Therefore, according to the embodiment, since the battery element 14 can be further suppressed from moving inside, the reliability of the laminated battery 10 can be further improved.

In the embodiment, the hard film 20 is preferably provided so as to cover the entire edge part 11b. Thus, a periphery of the main surface 11a to which the double-sided tape 30 is bonded can be entirely reinforced with the hard film 20, so that deformation of the laminate film 15 on the main surface 11a can be suppressed.

Therefore, according to the embodiment, since the battery element 14 can be further suppressed from moving inside, the reliability of the laminated battery 10 can be further improved.

Still more, in the embodiment, the hard film 20 is preferably made of a resin having a smaller elongation percentage than the first resin layer 15a and the second resin layer 15c. For example, in the embodiment, polypropylene having an elongation percentage of about 50(%) to 1000(%), polyethylene having an elongation percentage of about 200(%) to 500(%), or the like is used for the first resin layer 15a. In the embodiment, nylon having an elongation percentage of about 60(%) is used for the second resin layer 15c.

In the embodiment, polyethylene terephthalate having an elongation percentage of about 20(%), polyimide having an elongation percentage of about 4(%), or the like is preferably used for the hard film 20.

As a result, since the hard film 20 can be cut in advance into a predetermined shape and bent to be attached from the main surface 11a to the edge part 11b, the hard film 20 can be bonded to the entire main surface 11a and the entire edge part 11b simultaneously.

In other words, in the embodiment, the hard film 20 is made of a resin having a smaller elongation percentage than the first resin layer 15a and the second resin layer 15c, so that the hard film 20 can be easily bonded to the laminated battery 10. Therefore, according to the embodiment, a bonding cost of the hard film 20 can be reduced.

In the embodiment, the hard film 20 is not limited to a case of being made of resin, and may be any material as long as it is a material having a smaller elongation percentage than the first resin layer 15a and the second resin layer 15c (e.g., metal or the like).

In the embodiment, the elongation percentage of the hard film 20 is preferably 50(%) or less. Accordingly, when the external impact is applied, the battery element 14 can be firmly supported by the laminate film 15. Therefore, according to the embodiment, the reliability of the laminated battery 10 can be further improved.

In the embodiment, when the hard film 20 integrally formed is attached to the entire main surface 11a and the entire edge part 11b simultaneously, the hard film 20 bent at different portions may be attached without overlapping each other.

As a result, it is possible to suppress an increase in the thickness due to overlapping of the hard films 20, and thus, it is possible to suppress an increase in the space inside the electronic apparatus 1 required for protecting the laminated battery 10. Therefore, according to the embodiment, it is possible to suppress a decrease in the capacity of the laminated battery 10.

[Various Modifications]

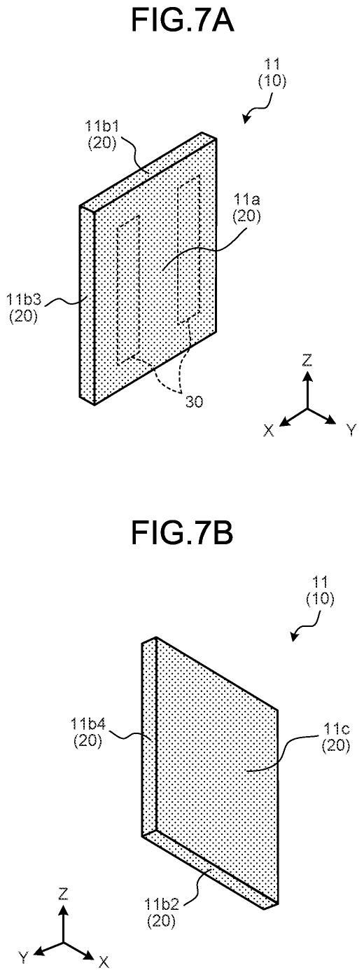

Next, various modifications of the embodiment will be described with reference to FIGS. 7A to 10B. FIG. 7A is an upper perspective view illustrating an arrangement of the hard film 20 with respect to the laminated battery 10 according to a first modification of the embodiment of the present disclosure, and FIG. 7B is a lower perspective view illustrating the arrangement of the hard film 20 with respect to the laminated battery 10 according to the first modification of the embodiment of the present disclosure.

In the main body 11 of the laminated battery 10 according to the first modification, as illustrated in FIGS. 7A and 7B, the hard film 20 is bonded to the entire one main surface 11a, the first edge part 11b1 to the fourth edge part 11b4 (i.e., entire edge part 11b), and the entire other main surface 11c. In other words, in the first modification, the entire surface of the main body 11 is covered with the hard film 20.

As a result, the entire laminate film 15 covering the battery element 14 can be made difficult to stretch by the hard film 20. Therefore, according to the first modification, since the battery element 14 can be further suppressed from moving inside, the reliability of the laminated battery 10 can be further improved.

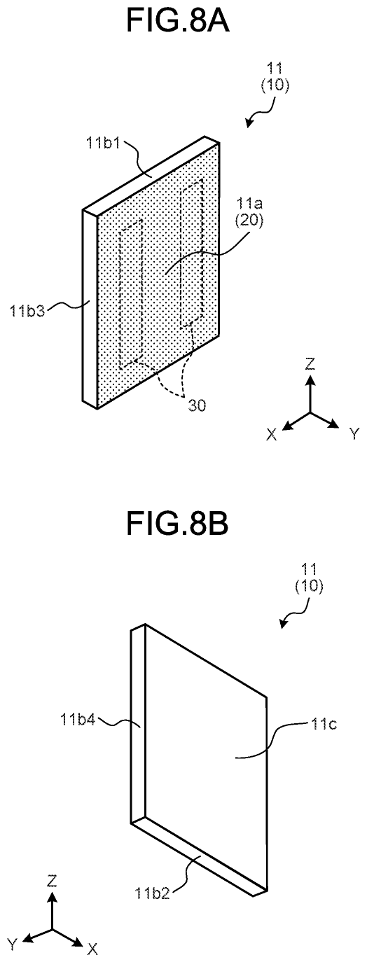

FIG. 8A is an upper perspective view illustrating an arrangement of the hard film 20 with respect to the laminated battery 10 according to a second modification of the embodiment of the present disclosure, and FIG. 8B is a lower perspective view illustrating the arrangement of the hard film 20 with respect to the laminated battery 10 according to the second modification of the embodiment of the present disclosure.

In the main body 11 of the laminated battery 10 according to the second modification, as illustrated in FIGS. 8A and 8B, the hard film 20 is bonded to the entire main surface 11a to which the double-sided tape 30 is attached. In other words, in the second modification, as compared with the embodiment illustrated in FIGS. 6A and 6B, the hard film 20 is not provided on most of the edge part 11b of the main body 11.

Even with such a configuration, since the hard film 20 is provided so as to cover the entire main surface 11a to which the double-sided tape 30 is attached, it is possible to suppress deformation of the laminate film 15 in the vicinity of the bonded portion to which the double-sided tape 30 is bonded and in the periphery of the bonded portion.

Therefore, according to the second modification, since the battery element 14 can be suppressed from moving inside, the reliability of the laminated battery 10 can be improved.

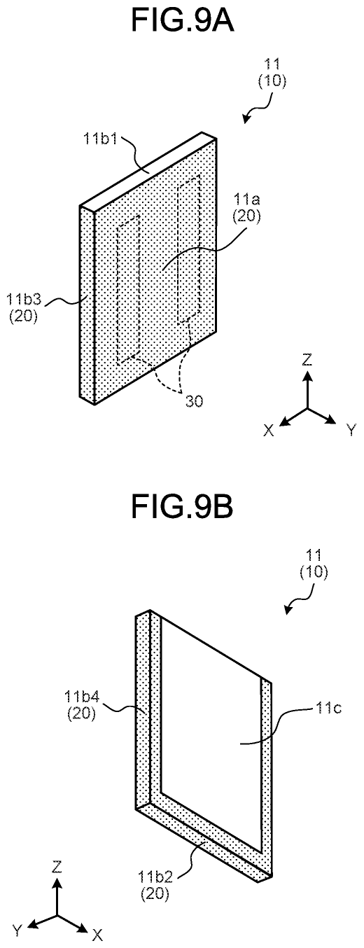

FIG. 9A is an upper perspective view illustrating an arrangement of the hard film 20 with respect to the laminated battery 10 according to a third modification of the embodiment of the present disclosure, and FIG. 9B is a lower perspective view illustrating the arrangement of the hard film 20 with respect to the laminated battery 10 according to the third modification of the embodiment of the present disclosure.

In the main body 11 of the laminated battery 10 according to the third modification, as illustrated in FIGS. 9A and 9B, the hard film 20 is bonded to the entire main surface 11a to which the double-sided tape 30 is attached and the second edge part 11b2 to the fourth edge part 11b4.

In other words, in the third modification, as compared with the embodiment, the hard film 20 is not provided on most of a portion (first edge part 11b1 in the third modification) of the edge part 11b including one of the side surfaces substantially perpendicular to the winding axis (i.e., Z-axis direction,) of the battery element 14.

Even with such a configuration, since the hard film 20 is provided so as to cover the entire main surface 11a to which the double-sided tape 30 is attached, it is possible to suppress deformation of the laminate film 15 in the vicinity of the bonded portion to which the double-sided tape 30 is bonded and in the periphery of the bonded portion.

Therefore, according to the third modification, since the battery element 14 can be suppressed from moving inside, the reliability of the laminated battery 10 can be improved.

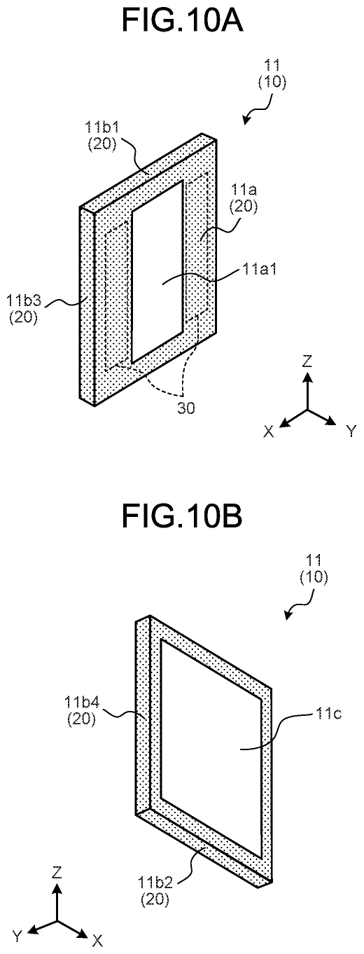

FIG. 10A is an upper perspective view illustrating an arrangement of the hard film 20 with respect to the laminated battery 10 according to a fourth modification of the embodiment of the present disclosure, and FIG. 10B is a lower perspective view illustrating the arrangement of the hard film 20 with respect to the laminated battery 10 according to the fourth modification of the embodiment of the present disclosure.

In the main body 11 of the laminated battery 10 according to the fourth modification, as illustrated in FIGS. 10A and 10B, the hard film 20 is bonded to a part of one main surface 11a and the first edge part 11b1 to the fourth edge part 11b4 (i.e., the entire edge part 11b). In other words, the entire edge part 11b is covered with the hard film 20 while a central portion 11a1 of the main surface 11a is not covered with the hard film 20 in the fourth modification.

Even with such a configuration, since the periphery of the main surface 11a to which the double-sided tape 30 is bonded can be entirely reinforced by the hard film 20, it is possible to suppress deformation of the laminate film 15 on the main surface 11a.

Therefore, according to the fourth modification, since the battery element 14 can be suppressed from moving inside, the reliability of the laminated battery 10 can be improved.

In the fourth modification, as illustrated in FIG. 10A, the hard film 20 is preferably provided at a portion of the main surface 11a to which the double-sided tape 30 is attached. In other words, in the fourth modification, the laminated battery 10 is preferably supported by the housing 2 (see FIG. 5) via the hard film 20.

As a result, it is possible to suppress deformation of the laminate film 15 in the vicinity of the bonding portion to which the double-sided tape 30 is bonded. Therefore, according to the fourth modification, since the battery element 14 can be further suppressed from moving inside, the reliability of the laminated battery 10 can be further improved.

### Effects

The electronic apparatus 1 according to the embodiment includes the laminated battery 10 and the hard film 20. The laminated battery 10 includes the battery element 14 and the laminate film 15 having the resin layer (first resin layer 15a, second resin layer 15c) and covering the battery element 14. The hard film 20 is bonded to at least a part of the surface of the laminated battery 10 and is made of a material having an elongation percentage smaller than that of the resin layer (first resin layer 15a, second resin layer 15c).

This makes it possible to secure both the capacity and reliability of the laminated battery 10.

The electronic apparatus 1 according to the embodiment further includes the support (housing 2) that supports the laminated battery 10. The laminated battery 10 is fixed to the support (housing 2) via the hard film 20.

As a result, the reliability of the laminated battery 10 can be further improved.

In addition, in the electronic apparatus 1 according to the embodiment, the hard film 20 is provided so as to cover the surface (main surface 11a) facing the support (housing 2) in the laminated battery 10.

As a result, the reliability of the laminated battery 10 can be further improved.

In the electronic apparatus 1 according to the embodiment, the laminated battery 10 has the flat plate shape, and the hard film 20 is provided so as to cover the entire edge part 11b of the laminated battery 10.

As a result, the reliability of the laminated battery 10 can be further improved.

In addition, in the electronic apparatus 1 according to the embodiment, the thickness of the hard film 20 is in the range from 30 μm to 100 μm.

As a result, both the capacity and reliability of the laminated battery 10 can be secured at a high level, and the workability of the hard film 20 can be improved.

In the electronic apparatus 1 according to the embodiment, the hard film 20 is made of a resin having the elongation percentage smaller than that of the resin layer (first resin layer 15a, second resin layer 15c).

As a result, the bonding cost of the hard film 20 can be reduced.

In addition, the laminated battery 10 according to the embodiment includes the main body 11 having the battery element 14 and the laminate film 15 having the resin layer (first resin layer 15a, second resin layer 15c) and covering the battery element 14. In addition, the hard film 20 made of a material having the elongation percentage smaller than that of the resin layer (first resin layer 15a, second resin layer 15c) is bonded to at least a part of the surface of the main body 11.

This makes it possible to secure both the capacity and reliability of the laminated battery 10.

The technical scope of the present disclosure is not limited to the above-described embodiments, and various modifications can be made without departing from the gist of the present disclosure. In addition, components of different embodiments and modifications may be appropriately combined.

For example, the above embodiment refers to the example in which the laminated battery 10 is supported on the housing 2 by the double-sided tape 30, but the laminated battery 10 may be supported on the housing 2 by using various fixing means other than the double-sided tape 30.

Note that the effects described in the present specification are merely examples and not limited, and other effects may be provided.

The present technique can also have the following configurations.

(1)

An electronic apparatus comprising:

a laminated battery including a battery element and a laminate film having a resin layer, the laminate film covering the battery element; and

a hard film that is bonded to at least a part of a surface of the laminated battery and is made of a material having an elongation percentage smaller than that of the resin layer.

(2)

The electronic apparatus according to the above (1) further comprising

a support that supports the laminated battery, wherein

the laminated battery is fixed to the support via the hard film.

(3)

The electronic apparatus according to the above (2), wherein

the hard film is provided so as to cover a surface of the laminated battery, the surface facing the support.

(4)

The electronic apparatus according to any one of the above (1) to (3), wherein

the laminated battery has a flat plate shape, and

the hard film is provided so as to cover an entire edge part of the laminated battery.

(5)

The electronic apparatus according to any one of the above (1) to (4), wherein

a thickness of the hard film is in a range from 30 μm to 100 μm.

(6)

The electronic apparatus according to any one of the above (1) to (5), wherein

the hard film is made of a resin having an elongation percentage smaller than that of the resin layer.

(7)

A laminated battery comprising

a main body including a battery element and a laminate film having a resin layer, the laminate film covering the battery element, wherein

the main body has a surface at least partially bonded to a hard film made of a material having an elongation percentage smaller than that of the resin layer.

(8)

The laminated battery according to (7), in which

the main body is fixed to the support of the electronic apparatus via the hard film.

(9)

The laminated battery according to (8), in which

the hard film is provided so as to cover the surface of the main body facing the support.

(10)

The laminated battery according to any one of the above (7) to (9) above, in which

the main body has the flat plate shape, and

the hard film is provided so as to cover the entire edge part of the main body.

(11)

The laminated battery according to any one of the above (7) to (10) above, in which

the thickness of the hard film is in the range from 30 μm to 100 μm.

(12)

The laminated battery according to any one of the above (7) to (11) above, in which

the hard film is made of the resin having the smaller elongation percentage than the resin layer.

### REFERENCE SIGNS LIST

1 ELECTRONIC APPARATUS
2 HOUSING (EXAMPLE OF SUPPORT)
10 LAMINATED BATTERY
11 MAIN BODY
11a, 11c MAIN SURFACE
11b EDGE PART
12 POSITIVE ELECTRODE TERMINAL
13 NEGATIVE ELECTRODE TERMINAL
14 BATTERY ELEMENT
15 LAMINATE FILM
15a FIRST RESIN LAYER (EXAMPLE OF RESIN LAYER)
15b METAL LAYER
15c SECOND RESIN LAYER (ANOTHER EXAMPLE OF RESIN LAYER)
20 HARD FILM
30 DOUBLE-SIDED TAPE

1. An electronic apparatus comprising:
a laminated battery including a battery element and a laminate film having a resin layer, the laminate film covering the battery element; and
a hard film that is bonded to at least a part of a surface of the laminated battery and is made of a material having an elongation percentage smaller than that of the resin layer.

2. The electronic apparatus according to claim 1 further comprising
a support that supports the laminated battery, wherein
the laminated battery is fixed to the support via the hard film.

3. The electronic apparatus according to claim 2, wherein
the hard film is provided so as to cover a surface of the laminated battery, the surface facing the support.

4. The electronic apparatus according to claim 1, wherein
the laminated battery has a flat plate shape, and
the hard film is provided so as to cover an entire edge part of the laminated battery.

5. The electronic apparatus according to claim 1, wherein
a thickness of the hard film is in a range from 30 μm to 100 μm.

6. The electronic apparatus according to claim 1, wherein
the hard film is made of a resin having an elongation percentage smaller than that of the resin layer.

7. A laminated battery comprising
a main body including a battery element and a laminate film having a resin layer, the laminate film covering the battery element, wherein
the main body has a surface at least partially bonded to a hard film made of a material having an elongation percentage smaller than that of the resin layer.
